(19) United States
(12) Patent Application Publication
(10) Pub. No.: US 2023/0131405 A1
(43) Pub. Date: Apr. 27, 2023

(54) METHOD AND DEVICE FOR MONITORING ESCALATOR

(71) Applicants: KONE CORPORATION, Helsinki (FI); KONE ELEVATORS CO., LTD., Kunshan, Jiangsu (CN)

(72) Inventors: Jinquan FAN, Kunshan (CN); Zhong CHEN, Kunshan (CN)

(73) Assignees: KONE CORPORATION, Helsinki (FI); KONE ELEVATORS CO., LTD., Kunshan, Jiangsu (CN)

(21) Appl. No.: 17/913,204

(22) PCT Filed: Mar. 17, 2021
(86) PCT No.: PCT/CN2021/081302

§ 371 Date: Sep. 21, 2022

(30) Foreign Application Priority Data
Mar. 24, 2020 (CN) 202010211781.4

(51) Int. Cl. G06V 10/26; G06V 10/44; G06V 10/56; G06V 20/52

(52) U.S. Cl. CPC G06V 10/26; G06V 10/44; G06V 10/56; G06V 20/52

(57) ABSTRACT

A method and device are disclosed for remotely monitoring an escalator. The method includes capturing an image of an escalator by means of a camera, wherein each step of the escalator is provided with a pattern of a predetermined color, the color of the pattern is different from the color of the step of the escalator; graying the captured image; covering the background of the grayed image, and separating the pattern; identifying the outline of the pattern; and comparing the identified pattern outline with a pre-stored pattern outline, and on the basis of the comparison result, determining whether the pattern on each step of the escalator is obstructed, wherein the pre-stored pattern outline is a non-obstructed pattern outline.

### CROSS-REFERENCE TO RELATED APPLICATIONS

The present application claims priority of China Patent application No. CN202010211781.4 filed on Mar. 24, 2020, the content of which is incorporated in its entirety as portion of the present application by reference herein.

### TECHNICAL FIELD

The present disclosure relates to a method for monitoring an escalator and a device for monitoring an escalator.

### BACKGROUND

At present, the turn-on and turn-off of an escalator generally depends on the staff going to the site for inspection and manually turn-on or turn-off a button of the escalator. This leads to a large amount of labor to the staff in a place with relatively large number of escalators. Therefore, it is needed to be able to remotely monitor the escalator to determine whether there is a passenger or an object on the escalator, so as to remotely turn-on or turn-off the escalator.

### SUMMARY

Therefore, the present disclosure provides a method for remotely monitoring an escalator, which includes: capturing an image of an escalator by a camera, wherein each step of the escalator is provided with a pattern with a predetermined color, and a color of the pattern is different from a color of steps of the escalator; performing a grayscale treatment to the image as captured; covering a background of the image being subjected to the grayscale treatment and separating the pattern; identifying an outline of the pattern; comparing the outline of the pattern with a pre-stored outline of the pattern, and determining whether the pattern on the step of the escalator is blocked according to a comparison result, wherein the pre-stored outline of the pattern is a non-blocked outline of the pattern.

Preferably, upon the comparison result showing that the outline of the pattern as identified is different from the pre-stored outline of the pattern, it is determined that the pattern on the step of the escalator is blocked.

Preferably, a case that the outline of the pattern as identified is different from the pre-stored outline of the pattern comprises a case that a number of non-blocked patterns is less than a pre-stored number of non-blocked patterns.

Preferably, upon the comparison result showing that the outline of the pattern as identified is the same as the pre-stored outline of the pattern, it is determined that the pattern on the step of the escalator is not blocked.

Preferably, a case that the outline of the pattern as identified is the same as the pre-stored outline of the pattern comprises a case that a number of non-blocked patterns is equal to a pre-stored number of non-blocked patterns.

Preferably, the pattern is arranged on a tread and/or a riser of each step of the escalator.

Preferably, the pattern is an oval pattern arranged at a center of the tread and/or the riser of each step of the escalator.

Preferably, the pattern is a boundary line arranged at a periphery of the tread and/or the riser of each step of the escalator.

The present disclosure further provides a device for remotely monitoring an escalator, which includes: a camera, configured for capturing an image of an escalator, wherein each step of the escalator is provided with a pattern with a predetermined color, and a color of the pattern is different from a color of steps of the escalator; a graying module, configured for performing a grayscale treatment to the image as captured; a separation module, configured for covering a background of the image being subjected to the grayscale treatment and separating the pattern; an identification module, configured for identifying an outline of the pattern; a processing module, configured for comparing the outline of the pattern with a pre-stored outline of the pattern, and determining whether the pattern on the step of the escalator is blocked according to a comparison result, wherein the pre-stored outline of the pattern is a non-blocked outline of the pattern.

Preferably, upon the comparison result showing that the outline of the pattern as identified is different from the pre-stored outline of the pattern, it is determined that the pattern on the step of the escalator is blocked.

Preferably, a case that the outline of the pattern as identified is different from the pre-stored outline of the pattern comprises a case that a number of non-blocked patterns is less than a pre-stored number of non-blocked patterns.

Preferably, upon the comparison result showing that the outline of the pattern as identified is the same as the pre-stored outline of the pattern, it is determined that the pattern on the step of the escalator is not blocked.

Preferably, a case that the outline of the pattern as identified is the same as the pre-stored outline of the pattern comprises a case that a number of non-blocked patterns is equal to a pre-stored number of non-blocked patterns.

Preferably, the pattern is arranged on a tread and/or a riser of each step of the escalator.

Preferably, the pattern is an oval pattern arranged at a center of the tread and/or the riser of each step of the escalator.

Preferably, the pattern is a boundary line arranged at a periphery of the tread and/or the riser of each step of the escalator

### BRIEF DESCRIPTION OF THE DRAWINGS

The advantages and objects of the present disclosure can be better understood from the following detailed description of the preferred embodiments of the present disclosure with reference to the accompanying drawings, in which:

FIG. 1 shows a flowchart of a method for monitoring an escalator according to the present disclosure.

FIG. 2(a) shows a pattern of a predetermined color provided on a step of an escalator.

FIG. 2(b) shows another pattern of a predetermined color provided on a step of an escalator.

FIG. 2(c) shows yet another pattern of a predetermined color provided on a step of an escalator.

FIG. 3 shows a schematic diagram of a pre-stored outline of an oval pattern.

FIG. 4 shows a schematic diagram of an image of an escalator captured by a camera.

FIG. 5 shows an outline of an oval pattern identified by the method of the present disclosure.

FIG. 6 shows a schematic diagram of a pre-stored outline of a boundary line pattern.

FIG. 7 shows a schematic diagram of an image of an escalator captured by a camera.

FIG. 8 shows an outline of the boundary line pattern identified by the method of the present disclosure.

### DETAILED DESCRIPTION

Various embodiments according to the present disclosure will be described in detail with reference to the accompanying drawings. Herein, it should be noted that in the drawings, the same reference numerals are given to constituent parts that basically have the same or similar structure and function, and repeated descriptions about them will be omitted. Unless otherwise specified, the terms “on”, “below”, “top”, “bottom”, “inner side” and “outer side” are all described with respect to the drawings of the present disclosure. The term “includes A, B, C, etc. in sequence” only indicates the sequence of the included components A, B, C, etc., and does not exclude the possibility of including other components between A and B and/or between B and C.

The inventive concept of the present disclosure is to determine whether there is a passenger or other object on the step of the escalator by remotely monitoring the escalator, so as to remotely turn-on or turn-off the escalator.

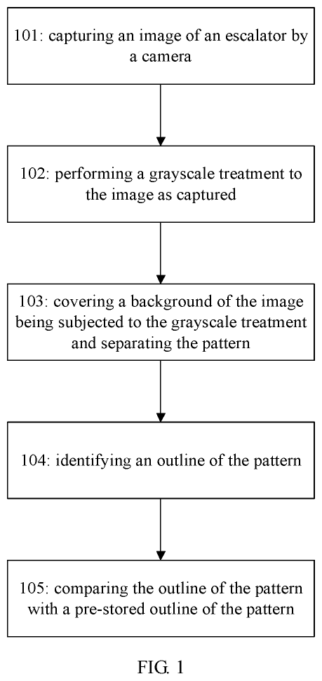

Hereinafter, referring to FIGS. 1 to 8, preferred embodiments according to the present disclosure are described in detail.

As illustrated by FIG. 1, a flowchart of a method for remotely monitoring an escalator according to the present disclosure is shown. In step 101, an image of an escalator is captured by a camera. The camera is configured that its field of view covers the whole escalator to capture the image of the whole escalator. One camera can be provided to capture the image of the whole escalator, or multiple cameras can be provided to capture the image of the escalator. In the case of multiple cameras, the images captured by multiple cameras are combined to form the image of the whole escalator.

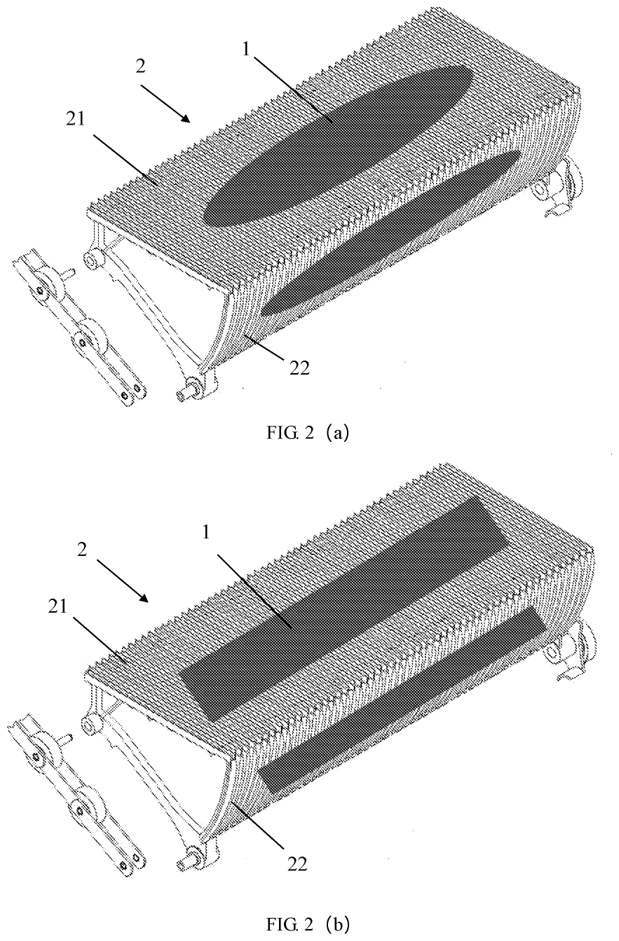

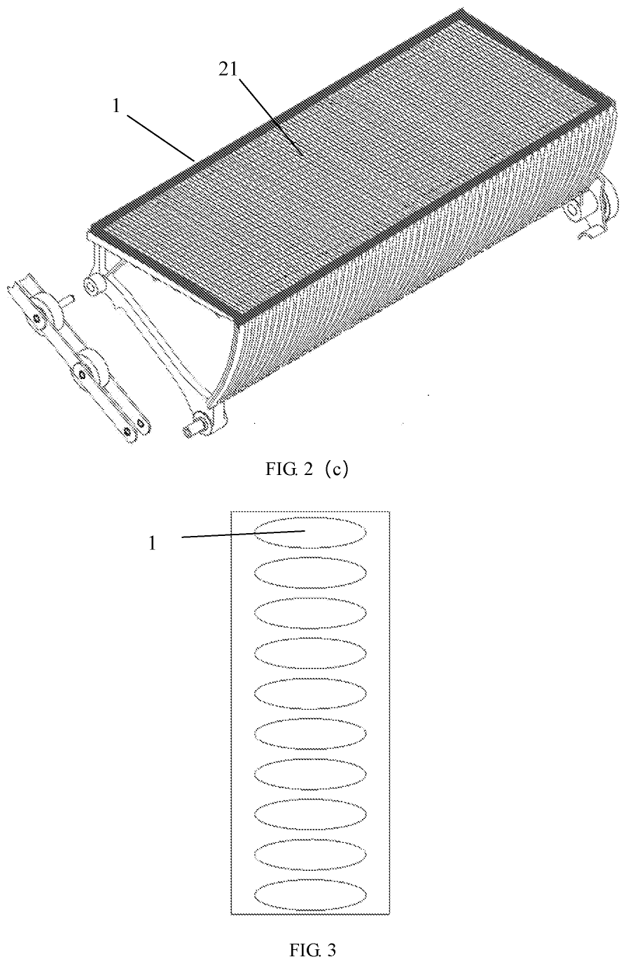

A pattern 1 with a predetermined color is provided on each step 2 of the escalator, preferably on a tread 21 and/or a riser 22 of each step. As illustrated by FIGS. 2(a) to 2(c), an oval pattern or a square pattern is arranged at the center of the tread and/or riser, and a pattern in a form of a boundary line is arranged at the periphery of the tread and/or riser. It should be understood by those skilled in the art that other arbitrary patterns can be used as long as the purpose of the present disclosure can be achieved. The colors of these patterns are different from the color of the steps of the escalator, so that these patterns can be distinguished in the subsequent processing.

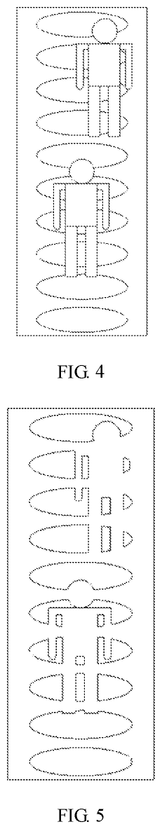

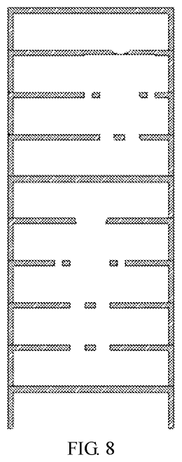

Next, in step 102, the image as captured is subjected to a grayscale treatment, so as to remove the color interference for subsequent processing, as illustrated by FIGS. 4 and 7, for example. In step 103, the background of the image being subjected to the grayscale treatment is covered to separate the pattern. In step 104, an outline of the pattern is identified, as illustrated by FIGS. 5 and 8, for example. The above image processing can use an HSV-based image processing method, which is well known to those skilled in the art and will not be described here again.

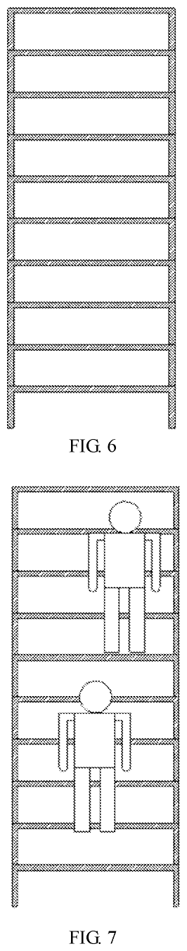

Finally, in step 105, the outline of the pattern as identified is compared with a pre-stored outline of the pattern. Based on the comparison result, it is determined whether the pattern on the step of the escalator is blocked. The pre-stored outline of the pattern is shown in FIGS. 3 and 6.

If the comparison result shows that the recognized pattern outline is different from the pre-stored outline of the pattern, then it is determined that the pattern on the step of the escalator is blocked, so that it is determined that there is a passenger or an object on the escalator. In this case, the escalator will not be remotely turned-on or turned-off. For example, if a number of non-blocked patterns is less than a pre-stored number of non-blocked patterns, it indicates that some patterns are blocked. If the comparison result shows that the comparison result showing that the outline of the pattern as identified is the same as the pre-stored outline of the pattern, it is determined that the pattern on the step of the escalator is not blocked, so that there are no passengers or objects on the escalator, and then the escalator can be turned-on or turned-off remotely. For example, the number of non-blocked patterns is equal to the pre-stored number of non-blocked patterns, which indicates that no pattern is blocked.

The present disclosure also provides a device for remotely monitoring an escalator, which includes a camera, configured for capturing an image of an escalator; a graying module, configured for performing a grayscale treatment to the image as captured; a separation module, configured for covering a background of the image being subjected to the grayscale treatment and separating the pattern; an identification module, configured for identifying an outline of the pattern; a processing module, configured for comparing the outline of the pattern with a pre-stored outline of the pattern, and determining whether the pattern on the step of the escalator is blocked according to a comparison result.

Through the method and device for remotely monitoring an escalator of the present disclosure, it is possible to conveniently and reliably determine whether there is a passenger or an object on the escalator, so as to remotely turn-on or turn-off the escalator, for example, turning-on the escalator in the morning and turning-off the escalator at night, without the staff spending too much labor.

Although the present disclosure has been specifically described above with reference to the preferred embodiments of the present disclosure, it should be understood that the present disclosure is not limited to the above-described embodiments, but various modifications and changes can be made by those skilled in the art without departing from the essence of the present disclosure, and these modifications and changes should fall within the scope defined by the appended claims and their equivalents.

1. A method for remotely monitoring an escalator, wherein the method comprises:
capturing an image of an escalator by a camera, wherein each step of the escalator is provided with a pattern with a predetermined color, and a color of the pattern is different from a color of steps of the escalator;
performing a grayscale treatment to the captured image;
covering a background of the image being subjected to the grayscale treatment and separating the pattern;
identifying an outline of the pattern;
comparing the outline of the pattern with a pre-stored outline of the pattern; and
determining whether the pattern on the step of the escalator is blocked according to a comparison result,
wherein the pre-stored outline of the pattern is a non-blocked outline of the pattern.

2. The method according to claim 1, wherein, upon the comparison result showing that the outline of the pattern as identified is different from the pre-stored outline of the pattern, determining that the pattern on the step of the escalator is blocked.

3. The method according to claim 2, wherein, a case that the outline of the pattern as identified is different from the pre-stored outline of the pattern comprises a case that a number of non-blocked patterns is less than a pre-stored number of non-blocked patterns.

4. The method according to claim 1, wherein, upon the comparison result showing that the outline of the pattern as identified is the same as the pre-stored outline of the pattern, determining that the pattern on the step of the escalator is not blocked.

5. The method according to claim 4, wherein, a case that the outline of the pattern as identified is the same as the pre-stored outline of the pattern comprises a case that a number of non-blocked patterns is equal to a pre-stored number of non-blocked patterns.

6. The method according to claim 1, wherein, the pattern is arranged on a tread and/or a riser of each step of the escalator.

7. The method according to claim 6, wherein, the pattern is an oval pattern arranged at a center of the tread and/or the riser of each step of the escalator.

8. The method according to claim 6, wherein, the pattern is a boundary line arranged at a periphery of the tread and/or the riser of each step of the escalator.

9. A device for remotely monitoring an escalator, wherein the device comprises:
a camera, configured for capturing an image of an escalator, wherein each step of the escalator is provided with a pattern with a predetermined color, and a color of the pattern is different from a color of steps of the escalator;
a graying module, configured for performing a grayscale treatment to the captured image;
a separation module, configured for covering a background of the image being subjected to the grayscale treatment and separating the pattern;
an identification module, configured for identifying an outline of the pattern; and
a processing module, configured for comparing the outline of the pattern with a pre-stored outline of the pattern, and determining whether the pattern on the step of the escalator is blocked according to a comparison result,
wherein the pre-stored outline of the pattern is a non-blocked outline of the pattern.

10. The device according to claim 9, wherein, upon the comparison result showing that the outline of the pattern as identified is different from the pre-stored outline of the pattern, it is determined that the pattern on the step of the escalator is blocked.

11. The device according to claim 10, wherein, a case that the outline of the pattern as identified is different from the pre-stored outline of the pattern comprises a case that a number of non-blocked patterns is less than a pre-stored number of non-blocked patterns.

12. The device according to claim 9, wherein, upon the comparison result showing that the outline of the pattern as identified is the same as the pre-stored outline of the pattern, it is determined that the pattern on the step of the escalator is not blocked.

13. The device according to claim 12, wherein, a case that the outline of the pattern as identified is the same as the pre-stored outline of the pattern comprises a case that a number of non-blocked patterns is equal to a pre-stored number of non-blocked patterns.

14. The device according to claim 9, wherein, the pattern is arranged on a tread and/or a riser of each step of the escalator.

15. The device according to claim 14, wherein, the pattern is an oval pattern arranged at a center of the tread and/or the riser of each step of the escalator.

16. The device according to claim 14, wherein, the pattern is a boundary line arranged at a periphery of the tread and/or the riser of each step of the escalator.
